(19) United States
(12) Patent Application Publication
(10) Pub. No.: US 2006/0062019 A1
(43) Pub. Date: Mar. 23, 2006

(54) Portable rechargeable night light

(76) Inventor: Jean Young, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/945,862

(22) Filed: Sep. 22, 2004

(51) Int. Cl. H01R 33/00

(52) U.S. Cl. 362/641

(57) ABSTRACT

This invention discloses a portable rechargeable night light, which comprises a replaceable luminous decorative object, a night light with an electric accumulator for emergency lighting, a base including an embedding module; a control circuit including a transformer for providing an operating power supply and a charge power supply through an electrically connected device with different voltages and setting a plurality of operating modes by a programmable control unit, and users select the setting through the module switch; a light emitting component electrically connected to and controlled by said control circuit to emitting light from a light emitting device from an end surface of the base to a luminous decorative object; and a luminous decorative object embedded on the base, of which the light emitting mode can be changed to select different operations and sensing effects of the light.

### FIELD OF THE INVENTION

The present invention relates to a night light, more particularly to a portable rechargeable night light.

### BACKGROUND OF THE INVENTION

A traditional night light usually comprises a housing having a power socket connected to a corresponding wall socket for obtaining electric power supply, a lamp base disposed at the top surface of the housing and installing a 3W bulb as a light source and a decorative external chassis. Some manufacturers adopt a rotary external chassis as a decorative lampshade. A general switch or a light-sensor switch is used for the control of turning on and off the night light. The light source of the prior-art night light generally adopts a single bulb or other light that can produce only one fixed color light source. In other words, the prior-art night light can provide a monotonous light source and a limited illumination, but cannot provide a light emitting method with sensory decorations to meet the requirements for special occasions such as parties or romantic atmosphere. The external chassis covered the exterior of the bulb is manufactured and shipped out from the factory as a fixed style, which does not allow consumers to make changes as they wish to meet their mood or interior decoration. If consumers really want to fulfill their requirements, they have to buy another model of night light. Then, one will keep many unused night lights in one's house, and thus causing a storage issue and wasting money. Further, the practical use of these night lights is to produce light when the power is turned on. However, unexpected power disconnection due to fire, earthquake or typhoon may occur, and the night light will lose its function completely. One may need to find a flashlight instead of obtaining the power for the illumination directly from a power accumulator of the night light or having light by holding the night light.

### SUMMARY OF THE INVENTION

It is therefore a primary objective of the present invention to provide a portable rechargeable night light, which comprises:

a base, including an embedding module;

a control circuit, including a transformer installed in said base and providing an operating power supply and a recharge power supply through various electrically coupled components of different voltages, and using a programmable control unit to set up a plurality of light emitting modules such that users can select the setting through a module switch to start a startup mechanism unit to drive a light emitting component according to the set module for the operation;

a light emitting component, being electrically coupled to said control circuit, and adopting the light emitting mode selected by the module switch, and producing a lighting effect on a decorative object by projecting the light from a light emitting position on the end surface of the base; and

a luminous decorative object, being fixed and embedded directly into the corresponding embedding module of said base through an embedding component at the bottom, so that users can change the night light anytime on their own.

### BRIEF DESCRIPTION OF THE DRAWINGS

FIG. 1 is a perspective view of some of the disassembled parts of the night light according to a preferred embodiment of the present invention.

FIG. 2 is a perspective view of the connecting module of the night light according to a preferred embodiment of the present invention.

FIG. 3 is a schematic circuit block diagram according to a preferred embodiment of the present invention.

FIG. 4 is a cross-sectional view of the night light according to a preferred embodiment of the present invention.

FIG. 5 is a cross-sectional view of the night light in use according to a preferred embodiment of the present invention.

FIG. 6 is a cross-sectional view of the structure of a night light according to a preferred embodiment of the present invention.

FIG. 7 is a schematic circuit block diagram of another preferred embodiment of the present invention.

### DETAILED DESCRIPTION OF THE PREFERRED EMBODIMENTS

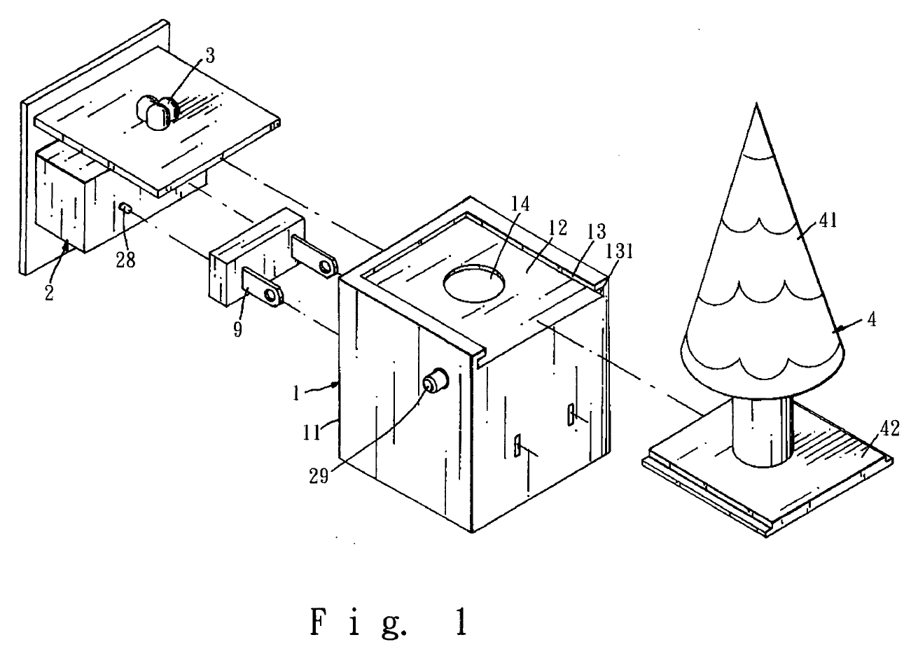

Please refer to FIGS. 1 to 5 for a preferred embodiment of the present invention. The night light according to the present invention comprises a base 1, a control circuit 2 and a light emitting device 3 both disposed on the base 1, and a replaceable luminous decorative object 4 as shown in FIG. 1. The light emitting method for the light emitting device 3 is selected and control by a module switch 23, and the operating power supply is input through a replaceable electrically coupled device 9 to fit different voltages.

The base 4 as shown in FIG. 1 comprises a built-in assembling space 11 for installing electric components such as the control circuit 2 and the light emitting component 3; and a light emitting space 12 containing an embedding module 13 and the surface of the light emitting space 12 has a light-transmittable means 14 (as shown in FIG. 1). Such device could be either an uncovered hole or a hole covered with a transparent sheet. In other embodiments, the surfaces of the base 1 or the light emitting space 12 can be made directly by a transparent material.

The foregoing embedding module 13 disposed on an end surface of the light emitting space 12 as shown in FIG. 1 is a unidirectional embedding groove 131 that provides a direct embedment or replacement for the luminous decorative object 4.

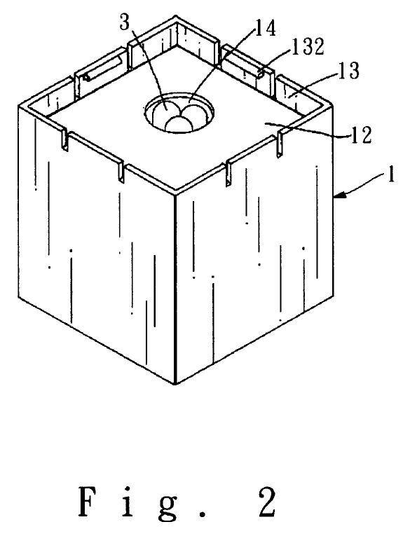

The embedding module 13 could also adopt other structure having the holding and positioning effect such as a flexible clamp 132 as shown in FIG. 2.

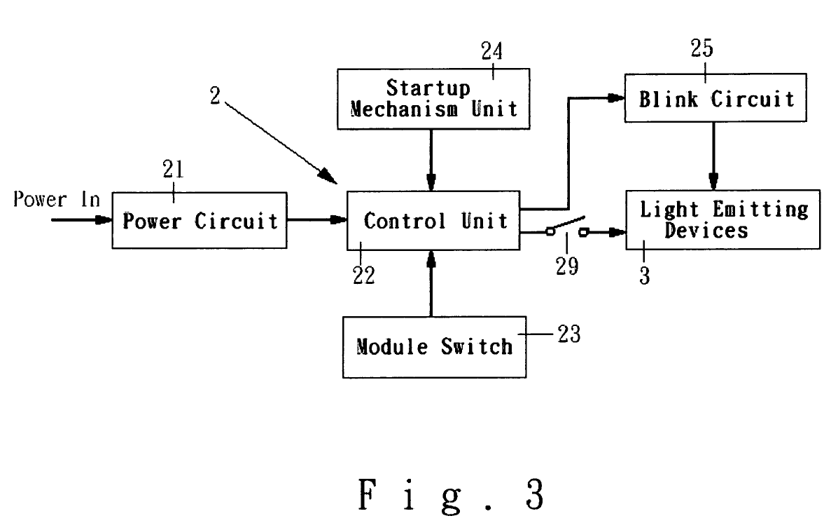

A control circuit 2 normally installed in the built-in assembling space 11 of the foregoing base 1. Please refer to FIG. 3 for a preferred embodiment of the present invention, which comprises a power circuit 21 including a transformer, a control unit 22, a module switch 23, a startup mechanism unit 24 and a blink circuit 25. The power circuit 21 is electrically coupled with an external power supply by an electric connector 9 such as a plug or an automobile cigarette lighter socket for introducing the external power required for the related operation. The control unit 22 could be a programmable single chip or a processor used in another embodiment that uses a programmable technique to set the light emitting mode for the light emitting device 3, and users can set up the modes through the module switch 23. When the control circuit 2 is switched on, the startup mechanism unit 24 operated according to the setup of the modular light emitting device 3 can be turned on and off for the control by a general switch of a light-sensor switch. Further, a switch device 29 is installed for a portable application when the power supply is removed from the night light, and such switch device 29 can be turned off when the user gets to a bright place or out of the danger.

The foregoing module switch 23 is used to select the operation mode, which includes the setup for at least two light emitting modes in the embodiments. In one of the two modes, all light emitting devices 3 emit continuous light simultaneously; and in the other mode, a blink circuit 25 is used to drive and control all light emitting devices 3 to emit light one by one according to a sequence or blink simultaneously. Users can select one of these modes on their own through the module switch 23.

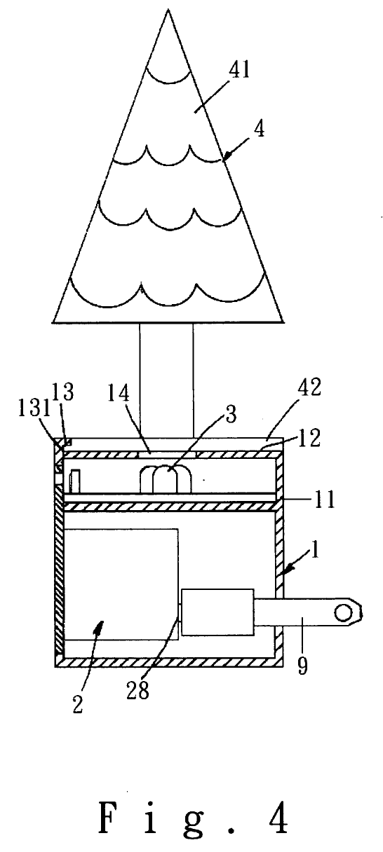

The foregoing power circuit 21 is electrically coupled with an electric connector 9 such as a plug. In a specific structure, the power circuit 21 includes a modular design of a power contact point 28 for an external connection, and the power contact point 28 can be made to fit an electric connector 9 of any different voltage directly in the factory as shown in FIG. 4 in order to select the corresponding voltage for a traditional transformer, or users can replace the electric connector 9 on their own to fit different voltages to cope with the adopted electronic transformer, and automatically detect the external voltage to fit the operating voltage for the operations of the control unit 22 and the light emitting device 3. A prior art structure can be used for changing the connection of an electric connector 9 to fit different voltages, and thus such method will not be described or depicted here.

In normal conditions, the light emitting device 3 is installed and fixed in the built-in assembling space 11 of the base 1 at a position corresponding to the light transmittable device 14 and electrically connected with the foregoing control circuit 2. Please refer to FIGS. 1 to 4 for the structure according to a preferred embodiment of the present invention. The light emitting device 3 adopts one or more light emitting diode 31 as shown in FIGS. 1 and 4. The preferred embodiment adopts three different colored light emitting diodes 31. Of course, one or more R.G.B. light emitting diode can be used instead to a more colorful light source.

The luminous decorative object 4 is a stylish plastic product made of a transparent material and preferably a color transparent substance or a colorless transparent substance for allowing the light emitting device 3 to project a light onto the luminous decorative object 4, and then emit the light from the luminous decorative object 4 to provide illumination in the nighttime. The structure according to a preferred embodiment as shown in FIG. 1 comprises a stylish decorative object 41 and an embedding module 42 at the bottom. The embedding module 42 preferably adopts the shape corresponding to the embedding module 13 of the foregoing base 1 for a tight embedment.

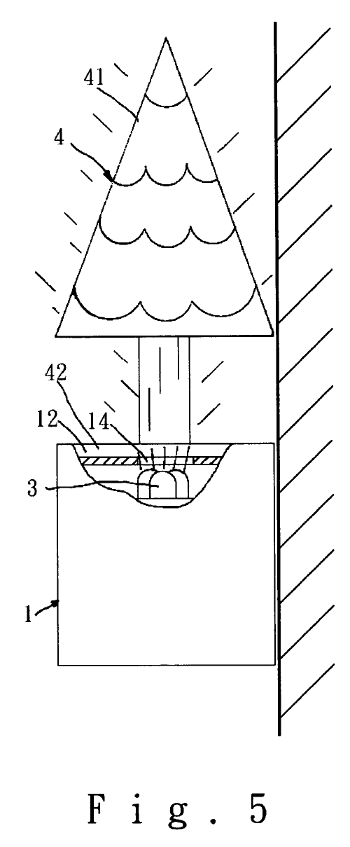

Please refer to FIG. 5 for the aforementioned preferred embodiment of the present invention. The base 1 uses an electric connector 9 to directly connect to a wall socket or select a power supply socket for obtaining an external power supply and regulating the voltage to an appropriate operating voltage by a transformer of the control circuit 21. If the light sensor switch or a general switch of the startup mechanism unit 24 is operated by the startup mechanism, the control unit 22 drives the light emitting device 3 to produce a continuous light source or a blinking light source according to the light emitting mode set at that time or the light emitting mode selected by the user through the module switch 23. If a power failure occurs, the control circuit 21 will detect the disconnection, and drive the light emitting device 3 according to the originally selected mode at that time to produce a continuous light source or a blinking light source for the emergency illumination or guide. The light source of the foregoing light emitting devices 3 will emit light from the light transmittable device 14 of the base 1 into a luminous decorative object 4, and the luminous decorative object 4 emits a light or a blinking light to provide different illuminations for the night light. In the meantime, the luminous decorative object 4 can be removed from the embedding module 12 of the base 1 and replaced by another luminous decorative object 4 with different styles or colors.

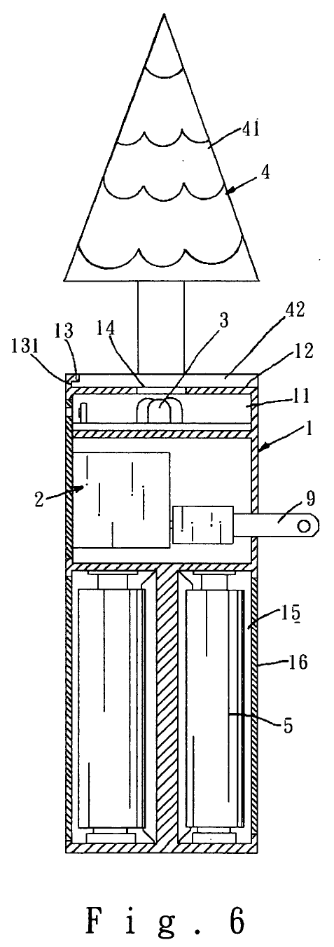

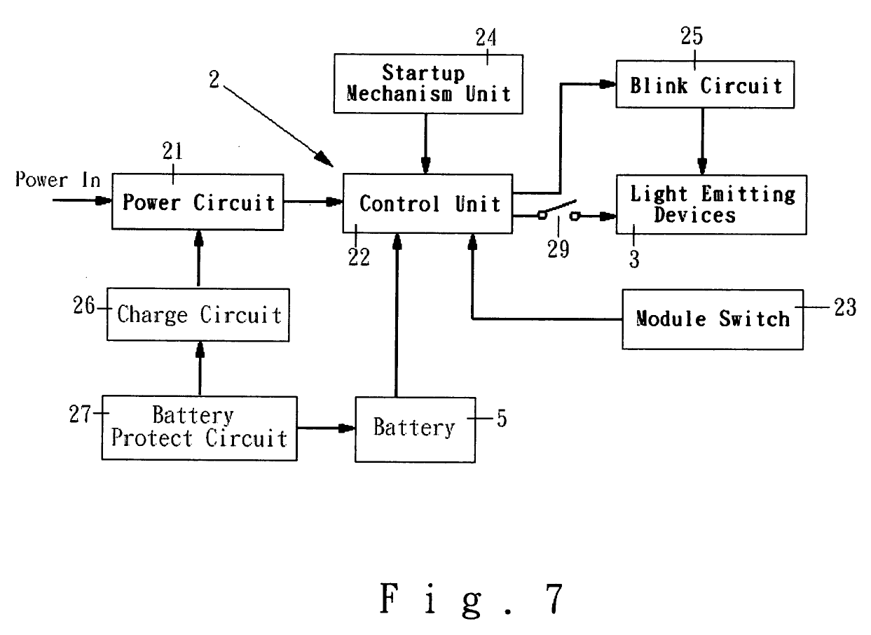

Please refer to FIGS. 6 and 7 for the structure of a night light according to another preferred embodiment of the present invention. The structure of the night light as shown in FIG. 6 also comprises a base 1, a control circuit 2 and a light emitting device 3 both disposed in a built-in assembling space 11 of the base 1, and a movably replaceable luminous decorative object 4 embedded in the light emitting space 12 of the base 1; wherein the base 1 also includes a built-in assembling space 11 and a light emitting space 12 including an embedding module 13 and a battery compartment 15 extended from the bottom of the base 1, and the battery compartments 15 depicted in FIG. 6 are installed symmetrically on both sides and covered by a lid 16, so that a plurality of rechargeable batteries 5 is a power accumulator under normal conditions. If the accumulated electric power loses its external power input, the power accumulator will start automatically to supply the power required for the operation of the night light and keep the light emitting device 3 to emit light continuously according to the set light emitting mode. Such arrangement also provides a labeled the position or a handheld position and serves as a tool for the emergency illumination. The test result shows that the power accumulation of the accumulated power supply is 100% full and is able to provide a continuous light emitting operation for the light emitting diode 31 for more than 24 hours.

The foregoing control circuit 2 as shown in FIG. 7 also comprises a power circuit 21 including a transformer, a control unit 22, a module switch 23, a startup mechanism unit 24 and a blink circuit 25. The control circuit 2 further comprises a charge circuit 26 electrically connected to the foregoing power circuit 21 to obtain the inputted power supply for charging a battery, a battery protect circuit 27 for preventing the surge voltage of the charge power and automatically stopping the battery charging operation when the battery 5 is fully charged to prevent damages to the battery due to the overcharge of the battery, and a switch device 29 for turning off the illumination of the night light.

The structure according to the design of another preferred embodiment of the present invention also produces a continuous light source or a blinking light source according to the user's selected light emitting mode to drive the light emitting device 3 to emit a light out from the luminous decorative object 4 when the startup mechanism is started in the same way as the foregoing embodiment.

In the meantime, the charge circuit 26 charges the battery 5 for a power accumulation in normal conditions. If emergency occurs, the charge circuit 26 can remain its connection to the wall socket for an electric connection with the light emitting module, or can be removed from the wall socket, so that users can hold the light and use the battery to supply the power for the emergency illumination.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable rechargeable night light, comprising:
a base, including an embedding module;
a control circuit, being disposed on said base and having an electric connector electrically coupled to an external power for providing an operating power supply and using a programmable control unit for setting a plurality of light emitting modes, such that users select a setting through a module switch for starting a startup mechanism unit and driving a light emitting device to operate according to said setting mode; and
a light emitting component, being electrically coupled to said control circuit and corresponsive to a light emitting position on an end surface of said base to transmit light to the exterior of said base.

2. The portable rechargeable night light of claim 1, wherein said base comprises a sealable built-in assembling space and a light emitting space containing an embedding module, and said light emitting space has a light-transmittable means disposed at an end surface for transmitting light.

3. The portable rechargeable night light of claim 2, wherein said light transmittable means is an uncovered hole.

4. The portable rechargeable night light of claim 2, wherein said light transmittable means is a hole covered with a transparent sheet.

5. The portable rechargeable night light of claim 1, wherein said embedding module is a construction having a clamping function.

6. The portable rechargeable night light of claim 5, wherein said embedding module is an embedding groove for selectively embedding and replacing a luminous decorative object.

7. The portable rechargeable night light of claim 5, wherein said embedding module is a construction having a flexible clamping device.

8. The portable rechargeable night light of claim 1, wherein said embedding module embeds a luminous decorative object having a function of responding and transmitting light.

9. The portable rechargeable night light of claim 8, wherein said luminous decorative object includes a stylish decorative member and an embedding device at its bottom, and said embedding device is in a shape corresponding to said base of said embedding module.

10. The portable rechargeable night light of claim 1, wherein said control circuit comprises:
a power circuit, including a transformer;
a control unit;
a module switch;
a startup mechanism unit;
a blink circuit; and
a switch device.

11. The portable rechargeable night light of claim 1, wherein said control circuit directly drives said light emitting device according to the original selected mode to selectively generate a continuous light and a blinking light as an emergency light and guide when an external power supply fails.

12. The portable rechargeable night light of claim 1, wherein said power circuit of said control circuit includes a modular design of an externally connected power contact point to cope with a direct replacement of said transformer for an electrically connected device of different voltages.

13. The portable rechargeable night light of claim 1, wherein said power circuit of said control circuit includes a modular design of an externally connected power contact point to cope with a transformer capable of automatically responding to an external voltage to switch the voltage corresponding to the operating voltage for users to change the voltage to fit different electric connectors.

14. The portable rechargeable night light of claim 1, wherein said light emitting device is a light emitting diode.

15. The portable rechargeable night light of claim 1, wherein said light emitting device comprises a plurality of light emitting diodes.

16. The portable rechargeable night light of claim 1, wherein said light emitting device is a monochromic light emitting diode.

17. The portable rechargeable night light of claim 1, wherein said light emitting device is a R.G.B. light emitting diode.

18. A portable rechargeable night light, comprising:
a base, including an embedding module;
a control circuit, being disposed on said base and having an electric connector electrically coupled to an external power for providing an operating power supply and using a programmable control unit for setting a plurality of light emitting modes, such that users select a setting through a module switch for starting a startup mechanism unit and driving a light emitting device to operate according to said setting mode; and
a light emitting component, being electrically coupled to said control circuit and corresponsive to a light emitting position on an end surface of said base to transmit light to the exterior of said base through a luminous decorative object.

19. A portable rechargeable night light, comprising:
a base, including an embedding module;
a control circuit, being disposed on said base and having an electric connector electrically coupled to an external power for providing an operating power supply and using a programmable control unit for setting a plurality of light emitting modes, such that users select a setting through a module switch for starting a startup mechanism unit and driving a light emitting device to operate according to said setting mode; and
a light emitting component, being electrically coupled to said control circuit and corresponsive to a light emitting position on an end surface of said base to transmit light to a luminous decorative object to emit light.

20. The portable rechargeable night light of claim 19, wherein said base comprises a sealable built-in assembling space, a light emitting space containing an embedding module, and said light emitting space has a light transmittable device disposed at an end surface, and a battery compartment disposed under said built-in assembling space.

21. The portable rechargeable night light of claim 19, wherein said battery compartment contains a rechargeable battery for charging said normally connected control circuit.

22. The portable rechargeable night light of claim 19, wherein said control circuit comprises:
a power circuit, including a transformer;
a control unit;
a module switch;
a startup mechanism unit;
a blink circuit; and
a charge circuit;
a battery protect circuit; and
a switch device.
